(19) United States
(12) Patent Application Publication
(10) Pub. No.: US 2026/0199750 A1
(43) Pub. Date: Jul. 16, 2026

(54) Pickleball Racket

(71) Applicant: HUDEF Sport Inc, Denver, CO (US)

(72) Inventor: Fabing Sun, Jiujiang (CN)

(21) Appl. No.: 19/025,282

(22) Filed: Jan. 16, 2025

(51) Int. Cl. A63B 59/42; A63B 102/08; B32B 3/12; B32B 3/18; B32B 5/18; B32B 27/06; B32B 27/08; B32B 27/32

(52) U.S. Cl. CPC A63B 59/42; B32B 3/12; B32B 3/18; B32B 5/18; B32B 27/065; B32B 27/08; B32B 27/32; A63B 2102/08; A63B 2209/02; B32B 2260/021; B32B 2260/04; B32B 2266/0221; B32B 2266/0271

(57) ABSTRACT

Disclosed is a pickleball racket including a racket body including a racket frame and a handle frame, where the handle frame is connected to a rear end of the racket frame, and an accommodating cavity is formed inside the racket frame and the handle frame; and a honeycomb core provided in a middle of the accommodating cavity, where a middle region of the honeycomb core is filled with a foaming filler, and an edge region of the honeycomb core is an air cavity. The foaming filler is filled in a central core region of the honeycomb core and the air cavity is reserved in the edge region, so that batting elasticity of a sweet spot can be increased and a batting speed can be increased, thereby increasing batting pleasure.

### TECHNICAL FIELD

The present disclosure relates to the field of pickleball rackets, and in particular to a pickleball racket.

### BACKGROUND

The pickleballs, which are as big as tennis balls, are thin-shell hollow balls made of hard plastic and have 26 holes with a diameter of about 1 cm. The rackets of tennis grip are as big as large-sized table tennis bats, initially made of wood, as well as lighter fiberglass, EVA, PE materials, honeycomb paper, hybrid materials, and carbon fiberboard. The existing pickleball racket has a honeycomb structure in the middle, and the honeycomb structure is filled with a solid in the middle, and batting elasticity is relatively uniform, which spoils batting pleasure of users with different requirements of batting force.

### SUMMARY

An object of the present disclosure is to provide a pickleball racket in order to solve the above problem.

The present disclosure achieves the above object by the following technical solution:
the present disclosure provides a pickleball racket including:
a racket body including a racket frame and a handle frame, where the handle frame is connected to a rear end of the racket frame, and an accommodating cavity is formed inside the racket frame and the handle frame;
a honeycomb core provided in a middle of the accommodating cavity, where a middle region of the honeycomb core is filled with a foaming filler, and an edge region of the honeycomb core is an air cavity; and
a connecting frame body including a racket frame portion and a handle portion, where the racket frame portion is provided between the racket frame and the honeycomb core, and the handle portion is provided in the accommodating cavity of the handle frame.

In some embodiments, the racket body is integrally formed from a foam material.

In some embodiments, the honeycomb core is made of PP, the honeycomb cavity of 1-3 layers of the honeycomb core from an edge is provided as the air cavity, and all the middle honeycomb cavities inside the air cavity are filled with a foaming filler.

In some embodiments, the foaming filler is made of epoxy foaming resin.

In some embodiments, the connecting frame body is made of EVA foam material, and the connecting frame body is formed through two hot working foaming treatments.

In some embodiments, an adhesive film is provided on the racket frame to cover the honeycomb core.

In some embodiments, a plurality of fiber-reinforced foams are provided on the honeycomb core.

In some embodiments, the fiber-reinforced foams are in form of strips.

In some embodiments, the fiber-reinforced foams are evenly spaced side-by-side along a length direction of the honeycomb core.

The beneficial effects are as follows: in the present application, the foaming filler is filled in a central core region of the honeycomb core and the air cavity is reserved in the edge region, so that batting elasticity of a sweet spot can be increased and a batting speed can be increased, thereby increasing batting pleasure. The connecting frame body made of the foam material is added between the honeycomb core and the racket frame, and the stability and firmness of the connection between the racket frame and the honeycomb core can be improved through two hot working foaming treatments, thereby improving durability.

### BRIEF DESCRIPTION OF FIGURES

In order to describe the examples of the present disclosure or the technical solution in the related art more clearly, brief introduction on drawings needed to be used in description of the examples and the related art will be made below. Apparently, the drawings in the description below are some examples of the present disclosure, and a person skilled in the art further can obtain other drawings according to the drawings without making creative efforts.

FIG. 1 is a front view according to the present disclosure (where region A is a core region filled with foaming filler);

FIG. 2 is a perspective view according to the present disclosure; and

FIG. 3 is an exploded view according to the present disclosure.

Reference numerals are described below:
100: racket body; 101: racket frame; 102: handle frame; 103: accommodating cavity; 200: connecting frame body; 300: honeycomb core; 301: foaming filler; 302: air cavity; 400: adhesive film; and 500: fiber-reinforced foam.

### DETAILED DESCRIPTION

In order to make objectives, technical solutions and advantages of the present disclosure clearer, the technical solution of the present disclosure will be further described in detail below. Apparently, the described examples are merely a part of examples of the present disclosure and are not all the examples. On the basis of the examples in the present disclosure, all other embodiments obtained by a person of ordinary skill in the art without creative efforts fall into the scope of protection of the present disclosure.

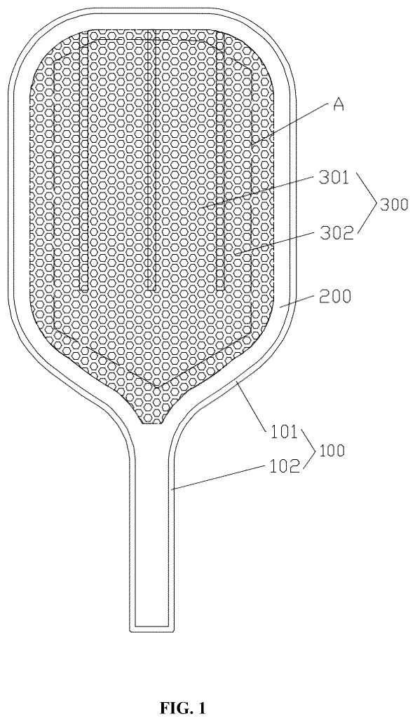

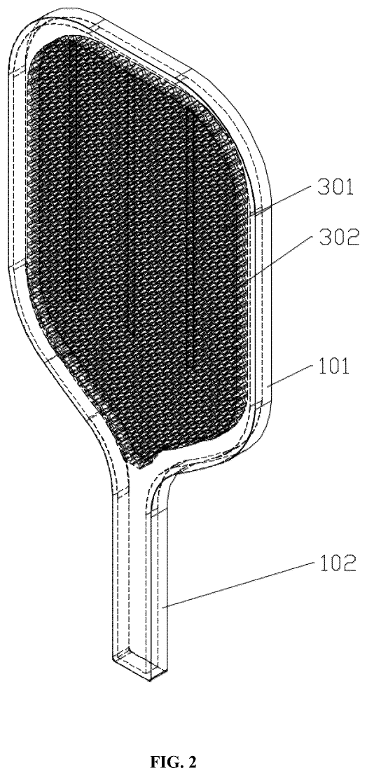

Referring to FIG. 1 to FIG. 3, the present disclosure provides a pickleball racket including a racket body 100, a honeycomb core 300, and a connecting frame body 200. The racket body 100 is integrally formed from a foam material.

The racket body 100 includes a racket frame 101 and a handle frame 102, where the handle frame 102 is connected to a rear end of the racket frame 101, and an accommodating cavity 103 is formed inside the racket frame 101 and the handle frame 102; and a honeycomb core 300 provided in a middle of the accommodating cavity 103, where a middle region (referring to the region A in FIG. 1) of the honeycomb core 300 is filled with a foaming filler 301, and an edge region of the honeycomb core 300 is an air cavity 302. The honeycomb core 300 is made of PP, the foaming filler 301 is made of epoxy foaming resin, the honeycomb cavity in a central core region of the honeycomb core 300 is filled with the foaming filler 301, and the air cavity 302 is reserved in the edge region, so that batting elasticity of a sweet spot can be increased and a batting speed can be increased, thereby increasing batting pleasure.

Referring to FIG. 1, a connecting frame body 200 includes a racket frame portion and a handle portion, where the racket frame portion is provided between the racket frame 101 and the honeycomb core 300, and the handle portion is provided in the accommodating cavity of the handle frame 102.

In some embodiments, the connecting frame body 200 is made of EVA foam material, and the connecting frame body 200 is formed through two hot working foaming treatments. A structure of the connecting frame body 200 formed of the EVA foam material is similar to a structure of the racket body 100, so that the honeycomb core 300 can be connected to the racket body 100 to improve the stability and security of the connection between the racket frame 101 and the honeycomb core 300, thereby improving durability.

Further, in some embodiments, the honeycomb core 300 is made of PP, the honeycomb cavity of 1-3 layers of the honeycomb core 300 from an edge is provided as the air cavity 302, and all the middle honeycomb cavities inside the air cavity 302 are filled with a foaming filler 301.

In some embodiments, an adhesive film 400 is provided on the racket frame 101 to cover the honeycomb core 300, and the honeycomb core 300 can be stably connected to the racket frame 101 by a structure covered with the adhesive film 400.

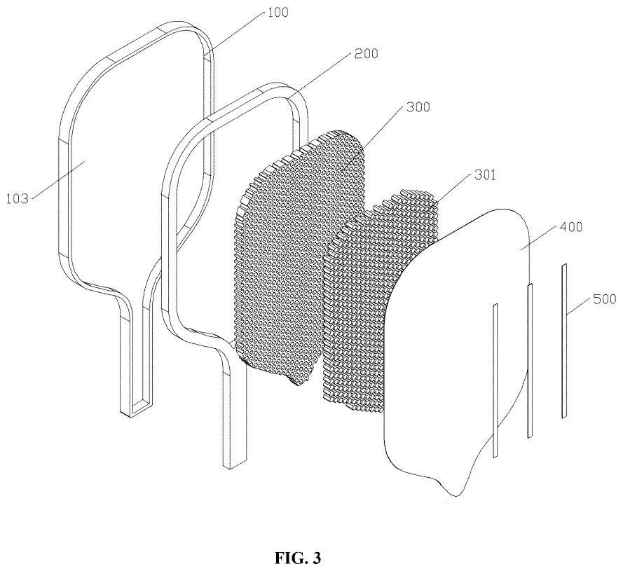

Further, as shown in FIG. 3, a plurality of fiber-reinforced foams 500 are provided on the honeycomb core 300 on the basis of any of the above-described examples. In some embodiments, the fiber-reinforced foams 500 are in form of strips.

The fiber-reinforced foams 500 are evenly spaced side-by-side along a length direction of the honeycomb core 300. Specifically, the fiber-reinforced foam 500 is provided in a number of three. The core region of the honeycomb core 300 is easily broken and the batting strength is insufficient, and by providing the fiber-reinforced foam 500, it is possible to reduce the damage to the central core region of the honeycomb core 300 and the racket strength can be improved, and at the same time, the batting noise can be reduced and the sound of the batting can be made lower.

The above is merely the specific implementations of the present disclosure and is not intended to limit the scope of protection of the present disclosure. Any variations or replacements apparent to a person skilled in the art within the technical scope disclosed by the present disclosure shall fall within the scope of protection of the present disclosure. Therefore, the scope of protection of the present disclosure shall be subject to the scope of protection of the claims.

What is claimed is:

1. A pickleball racket, comprising:
a racket body comprising a racket frame and a handle frame, wherein the handle frame is connected to a rear end of the racket frame, and an accommodating cavity is formed inside the racket frame and the handle frame;
a honeycomb core provided in a middle of the accommodating cavity, wherein a middle region of the honeycomb core is filled with a foaming filler, and an edge region of the honeycomb core is an air cavity; and
a connecting frame body comprising a racket frame portion and a handle portion, wherein the racket frame portion is provided between the racket frame and the honeycomb core, and the handle portion is provided in the accommodating cavity of the handle frame.

2. The pickleball racket according to claim 1, wherein the racket body is integrally formed from a foam material.

3. The pickleball racket according to claim 2, wherein the honeycomb core is made of PP, the honeycomb cavity of 1-3 layers of the honeycomb core from an edge is provided as the air cavity, and all the middle honeycomb cavities inside the air cavity are filled with a foaming filler.

4. The pickleball racket according to claim 3, wherein the foaming filler is made of epoxy foaming resin.

5. The pickleball racket according to claim 1, wherein the connecting frame body is made of EVA foam material, and the connecting frame body is formed through two hot working foaming treatments.

6. The pickleball racket according to claim 1, wherein an adhesive film is provided on the racket frame to cover the honeycomb core.

7. The pickleball racket according to claim 1, wherein a plurality of fiber-reinforced foams are provided on the honeycomb core.

8. The pickleball racket according to claim 7, wherein the fiber-reinforced foams are in form of strips.

9. The pickleball racket according to claim 8, wherein the fiber-reinforced foams are evenly spaced side-by-side along a length direction of the honeycomb core.
